(19) United States
(12) Patent Application Publication
(10) Pub. No.: US 2010/0099841 A1
(43) Pub. Date: Apr. 22, 2010

(54) Nail polish

(76) Inventor: Jen-Meng Lin, Gueiren Township (TW)

Correspondence Address: Jen-Meng LIN, P.O. Box 6-9 717, Tainan, TW

(21) Appl. No.: 12/287,922

(22) Filed: Oct. 16, 2008

(51) Int. Cl. C08G 63/06

(52) U.S. Cl. 528/361

(57) ABSTRACT

This invention provides a kind of nail polish that has Amorphous Poly Lactic Acid resin extracted from plants as the basic material. Because the nail polish's basic material is Amorphous Poly Lactic Acid resin refined from plant material, it is bio-degradable, making it a more environmentally friendly nail polish basic material.

### BACKGROUND OF THE INVENTION

1. Field of the Invention

This invention is a kind of nail polish, specifically a kind that has Amorphous Poly Lactic Acid resin refined from plant material as the base material. The nail polish base material is bio-degradable, making it more environmentally friendly.

2. Description of the Prior Art

The base material of nail polishes in the market today is refined from petrochemicals. When the user applies the nail polish to their nails the nails may be damaged because the base material refined from petrochemicals is very dense and, when it is applied to nails it create an occlusive cover, the lack of air permeability damaging the nails. Also, when the nail polish is removed, residue pollutes the environment. Large numbers of people use nail polish so there is a high level of accumulated pollution, damaging the environment.

In addition, the number of nail polish users can be conservatively estimated to be over 100 million. If every person uses one gram each day, the total is over 100,000 kilograms, causing an inestimable amount of pollution. This shows the massive pollution cause by petrochemical-refined nail polish base material.

### SUMMARY OF THE INVENTION

The objective of this invention: provide an Amorphous Poly Lactic Acid resin nail polish base material refined from plant material that is bio-degradable and will thus not pollute the environment.

### DETAILED DESCRIPTION OF THE PREFERRED EMBODIMENT

Firstly, the preferred embodiment of this invention uses Amorphous Poly Lactic Acid resin as the nail polish base material. The Amorphous Poly Lactic Acid resin is refined from plant material. When it is applied it can be mixed with nail polish color formulas (0.5%-5%), allowing the user to choose the nail polish color they want. This nail polish is also bio-degradable.

The above description shows that this preferred embodiment has the following advantages:

1. This invention is refined from plants (ie corn) so it will bio-degrade and will not leave behind any pollution.

2. Because this invention is refined from plants it is safer to use and will not leave behind any chemical residue.

3. When applied to the nails, this nail polish has relatively good air permeability so will not be a burden for nails.

4. Traditional nail polish is dense and when applied to nails it creates an occlusive cover on the nails, this lack of air permeability leading to nail damage

While the preferred embodiment of the invention has been described above, it will be recognized and understood that various modifications may be made therein and the appended claims are intended to cover all such modifications that may fall within the spirit and scope of the invention.

What is claimed is:

1. A nail polish is made from Amorphous Poly Lactic Acid resin base material refined from plant material. Using nail polish made from Amorphous Poly Lactic Acid resin will effectively reduce pollution and provide a nail polish that is more air permeable.

2. The nail polish as claimed of claim 1, wherein the Amorphous Poly Lactic Acid resin base material of which is refined from corn. After the user removes the nail polish by cleaning the nail polish will bio-degrade so will not pollute the environment.

3. The nail polish as claimed of claim 1, wherein to the Amorphous Poly Lactic Acid resin base material of which nail polish color formulas (0.5%˜5% ) can be added to create colored nail polish.
